(19) United States
(12) Patent Application Publication
(10) Pub. No.: US 2003/0008587 A1
(43) Pub. Date: Jan. 9, 2003

(54) Compound cloth having base material made of multi-hollow fibers

(76) Inventor: Hong-Jung Chen, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/899,165

(22) Filed: Jul. 6, 2001

(51) Int. Cl. D04B 7/16; D04H 5/02; B32B 5/26; D04B 7/00

(52) U.S. Cl. 442/338; 442/306; 442/309; 442/402; 442/328; 442/381

(57) ABSTRACT

A compound cloth comprises a first cloth sheet, a second cloth sheet, and an elastic base material sandwiched between said first cloth sheet and said second cloth sheet. The base material is formed of stacking multi-hollow fibers. The multi-hollow fibers are made of polymer, such as PET, which have been processed by thermal spray, needle punching and wind cooling.

### FIELD OF THE INVENTION

The present invention relates generally to a cloth, and more particularly to a compound cloth having base material made of multi-hollow fibers.

### BACKGROUND OF THE INVENTION

The compound cloth of the prior art is composed of a thin sheet of knitcloth and a thin sheet of foam material, such as foam cotton, ethylene vinyl acetate (EVA), neoprene, etc., which is bonded on said knitcloth for enhancing the strength and sock-absorbing ability of the knitcloth. Such a prior art compound cloth as described above has an environmental problem when it is manufactured or recycled. Besides, the foam material has various disadvantages when it is used. The deformation and wrinkle of the foam material will exist easily when it is forced by an external force. The foam material, EVA or Neoprene for example, has a low permeability, elasticity and flexibility. The foam material, foam cotton for example, has an aging problem and a yellowing problem.

There is another prior art laminated cloth, which is composed of two thin sheets of knitcloth and a support layer sandwiched between the two parallel knitcloth sheets. The support layer is made of a plurality of fibers extending vertically and interconnecting to said two thin sheets. This laminated cloth is soft and compressible, however its compressibility is poor in light of the limited number and length of the fiber of the support layer. In addition, such laminated cloth is expensive.

There is still another prior art compressible laminated cloth, which is composed of two knitcloth layers and a compressible hairy layer integrally connected with one of said knitcloth layers such that said hairy layer is sandwiched between said two knitcloth layers. However, the flexibility, resilience and elasticity of such a prior art laminated cloth are poor.

### SUMMARY OF THE INVENTION

The primary object of the present invention is to provide a compound cloth which is rich in sock-absorbing ability, flexibility, resilience and elasticity.

Another object of the present invention is to provide a compound cloth which can be recycled easily.

The compound cloth of the present invention comprises a first cloth sheet, a second cloth sheet, and an elastic base material sandwiched between said first cloth sheet and said second cloth sheet. The base material is formed of stacking multi-hollow fibers.

### BRIEF DESCRIPTION OF THE DRAWINGS

FIG. 1 shows a perspective schematic view of a preferred embodiment of the present invention.

FIG. 2 shows an exploded view of the preferred embodiment of the present invention.

FIG. 3 shows an enlarged sectional view of the multi-hollow fiber of the present invention.

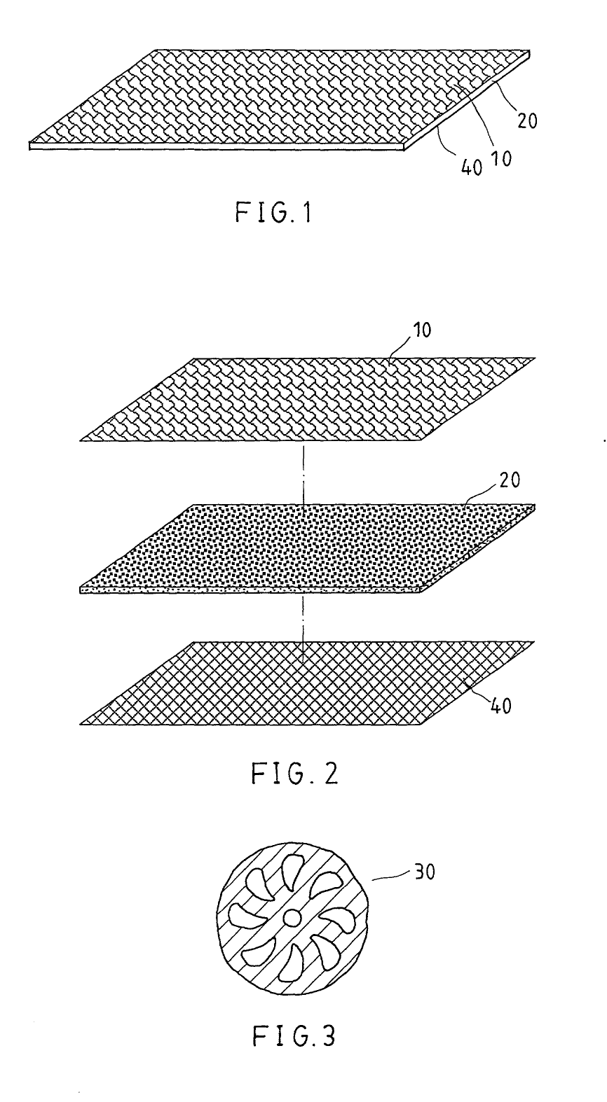

### DETAILED DESCRIPTION OF THE INVENTION

As shown in all drawing provided herewith, a compound cloth of a preferred embodiment of the present invention comprises the following component.

A first cloth sheet 10 is a plain cloth, knitted cloth or a nonwoven cloth which are made of natural fibers, synthetic fibers or compound fibers of the natural fibers and synthetic fibers.

An elastic base material 20 is bonded on a face of the first cloth sheet 10 by adhesive or stitching and is formed of stacking a plurality of multi-hollow fibers 30. The multi-hollow fiber 30 is made of polymer, such as polypropylene (PP) or polyethylene terephthalate (PET), which has been processed by thermal spray, needle punching and wind cooling. As shown in FIG. 3, the multi-hollow fiber 30 is a single fiber provided in the interior with a plurality of pores extending along its axis such that it is light in weight and has an excellent air permeability. Besides, PP or PET can be recycled from the discarded containers made of the same. The thickness of the base material or the number of pores of the multi-hollow fiber can be determined by the manufacturer.

A second cloth sheet 40 can be a plain cloth, knitted cloth or a nonwoven cloth which are made of natural fibers, synthetic fibers or compound fibers of the natural fibers and synthetic fibers. The second cloth sheet 40 is bonded on said base material 20 by adhesive or stitching such that the base material 20 is sandwiched between said first cloth sheet 10 and said second cloth sheet 40.

Another preferred embodiment of the present invention comprises the all components described above and superimposes step by step another elastic base material and a third cloth sheet thereon to form a compound cloth of five layers.

The effect of the present invention are described as follows:

1. The multi-hollow fiber has a plurality of interior pores which are filled with air therein such that the compound cloth of the present invention has excellent breathe ability and resilience, and it is warm.

2. The multi-hollow fiber of the present invention is light in weight and won't fatigue easily.

3. The compound cloth of the present invention has an excellent flexibility and the first and second cloth sheets 10, 40 can be made of any kind of material.

4. The multi-hollow fibers are resistant to aging, yellowing and heat pressure such that the compound cloth of the present invention is able to replace the prior art laminated cloth and can be used in making shoes, exercise devices, bags, etc.

5. The multi-hollow fiber of the base material can be made of PET which can be recycled from the discarded containers made of the same. In addition, the first and second cloth sheets can be made of reproduction cloth too. As a result, the present invention can be recycled easily and has an excellent benefit of protecting the environment in which we live.

Although the present invention has been illustrated and described with reference to the preferred embodiment thereof, it should be understood that it is no way limited to the details of such embodiment but is capable of numerous modifications within the scope of the appended claims.

What is claimed is:

1. A compound cloth comprising:
a first cloth sheet;
an elastic base material attached to one face of said first cloth sheet and formed of multi-hollow fibers;
a second cloth sheet attached to said elastic base material such that said elastic base material is sandwiched between said first cloth sheet and said second cloth sheet.

2. The compound cloth as defined in claim 1, wherein said elastic base material is adhesively connected to said first cloth sheet and said second cloth sheet.

3. The compound cloth as defined in claim 1, wherein said elastic base material is connected to said first cloth sheet and said second cloth sheet by stitching.

4. The compound cloth as defined in claim 1, wherein said multi-hollow fibers of said base material are made of stacking polymer fibers which have been processed by thermal spray, needle punching and wind cooling.

5. The compound cloth as defined in claim 1, wherein said first cloth sheet is selected form the group consisting of knitted cloth and nonwoven cloth which are made of natural fibers, synthetic fibers or compound fibers therebetween.

6. The compound cloth as defined in claim 1, wherein said second cloth sheet is selected form the group consisting of knitted cloth and nonwoven cloth which are made of natural fibers, synthetic fibers or compound fibers therebetween.

7. The compound cloth as defined in claim 1, wherein said elastic base material further comprises nonmulti-hollow fibers.
